(19) United States
(12) Patent Application Publication
(10) Pub. No.: US 2005/0045841 A1
(43) Pub. Date: Mar. 3, 2005

(54) Transverse disc motor

(76) Inventor: Delbert Lee Hartman, Edgewood, NM (US)

Correspondence Address: Delbert Lee Hartman, 68 Juniper Hills, Edgewood, NM, 87015, US

(21) Appl. No.: 10/646,181

(22) Filed: Aug. 25, 2003

(51) Int. Cl. F16K 31/02

(52) U.S. Cl. 251/129.11

(57) ABSTRACT

This invention relates to a turbine type motor having at least two rotating disc, mounted, housed, and geared together so that one rotates transverse to the other. The disc, one or more of which has an aperature in its perimeter the other having a projection or projections from its perimeter, intersect in a timed sequence so as to receive or produce power or to transfer liguids or gases.

### BACKGROUND OF THE INVENTION

The transverse disc motor under consideration has been designed to incorporate the advantages of both piston and turbine type motors and to avoid their disadvantages.

Piston type motors having numerous moving parts which continously stop and start, operate at relatively low temperatures, and thus do not fully utilize the fuel and are very frictional, necessitating lubicants. Which despite the very best seals and gaskets leak from the motor into the environment and cannot be recovered. Despite these problems the piston motor has one advantage, it can take relatively small amounts of fuel or pressure and, convert it into a very directional force, where as turbines rely on a bounce effect in which a great deal of energy is lost, or is even counterproductive. However because the turbine incorporates very few moving parts and those parts move in only one direction and are nearly frictionless, the turbine has replaced the piston in large power installations.

### SUMMARY OF THE INVENTION

It is the object of this invention to replace both of the aforementioned motors with one that as nearly as possible incorporates the directional force of the piston type and the continous rotation, near frictionless, minimal moving parts of the turbine type. It is the premise of this invention that a rotating disc mounted on the appropriate bearings can withstand substantial side force without greatly affecting the amount of power required for its rotation.

### BRIEF DESCRIPTION OF DRAWINGS

FIG. 1 is a top section view of the transverse disc motor and partial housings.

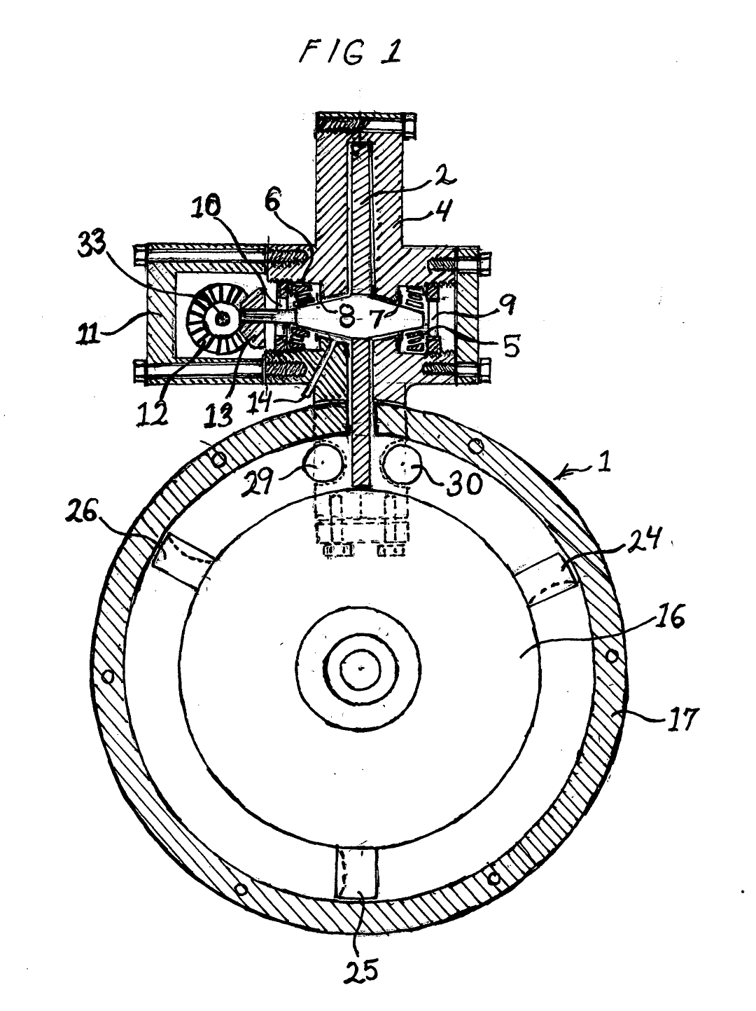

FIG. 2 is a sectional side view of the transverse disc motor and partial housings.

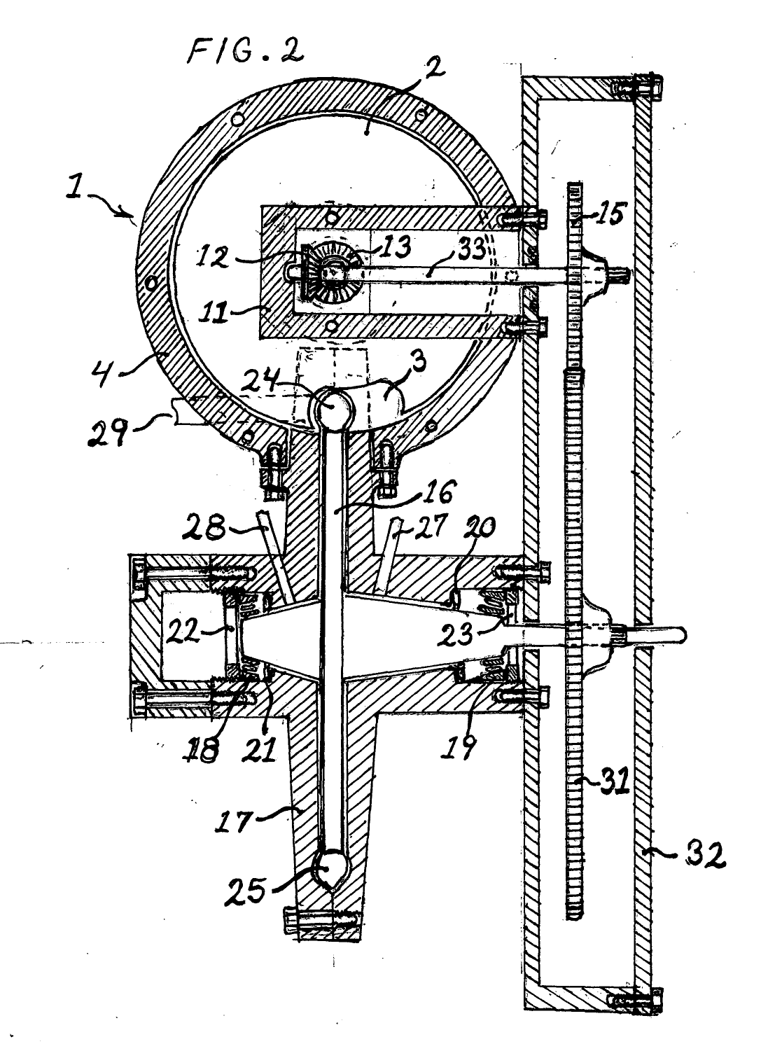

FIG. 3 is a top elevation view of the housings minus the timing and fly gear housing.

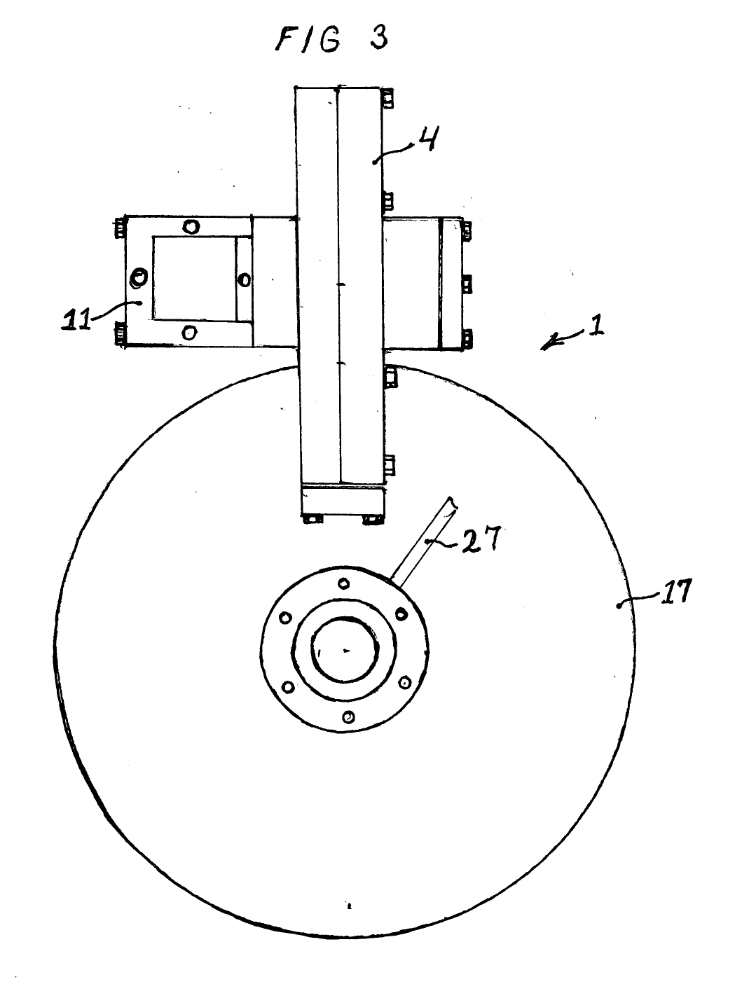

FIG. 4 is a elevation view of the transverse disc motor from the valve disc end.

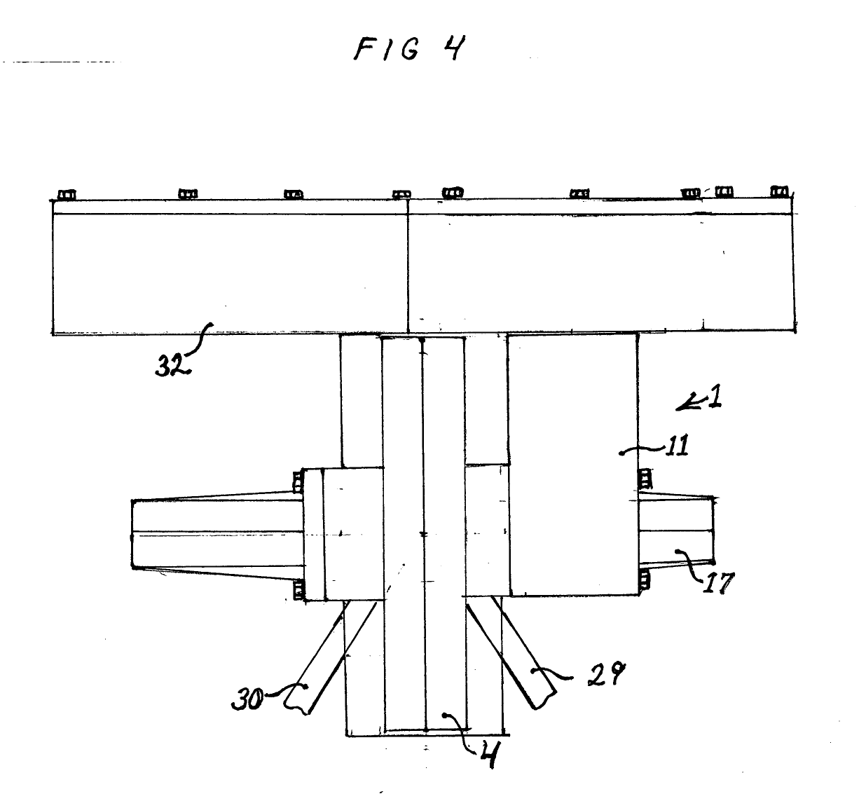

FIG. 5 is a top elevation view of the fly gear and timing gear and a partial of their housing.

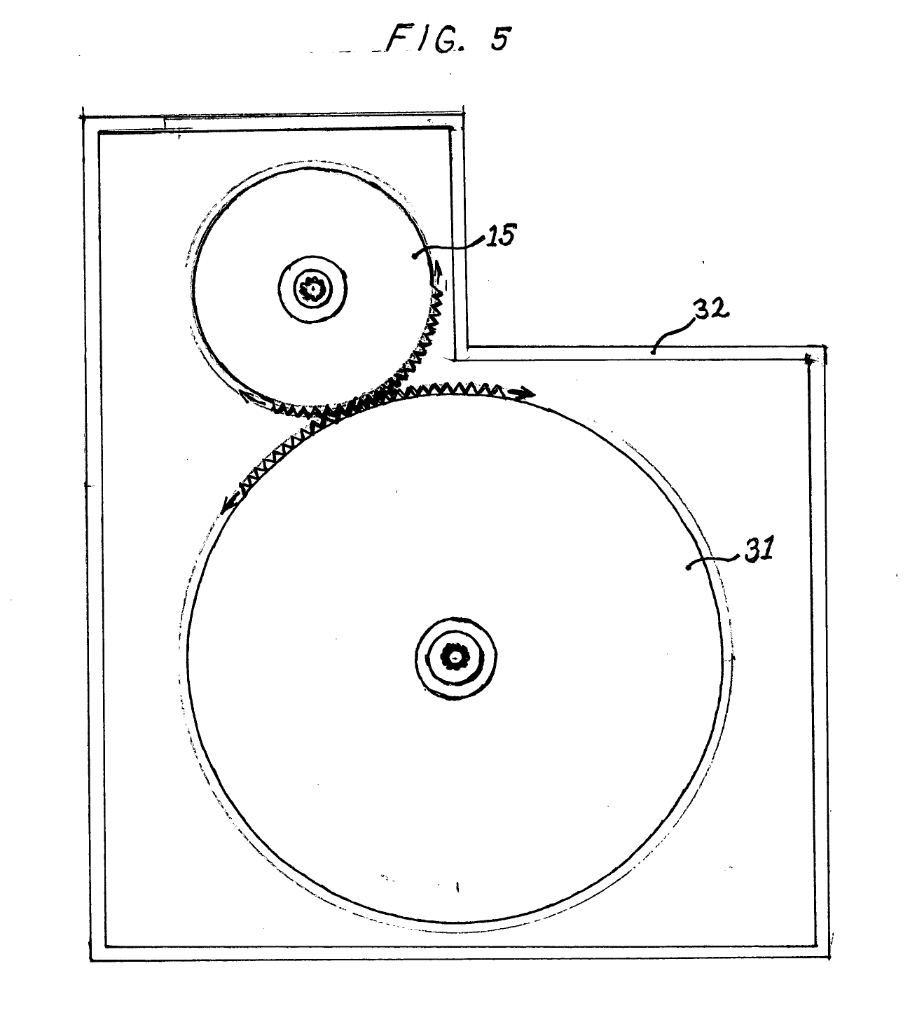

### DETAILED DESCRIPTION OF THE INVENTION

Referringing now specifically to the drawings. The numeral 1 refers to the transverse disc motor. The motor includes a valve disc 2 with its aperture 3, housings 4, seals 7 and 8, bearings 5 and 6, adjusters 9, and 10, a gear box 11, a pair of corner gears 12 and 13, a pressure vent 14, and a timing gear 15.

The moter also includes a power disc 16 with its housing 17, its bearings 18 and 19, seals 20 and 21, adjusters 22 and 23, power cups 24, 25 and 26, pressure vents 27 and 28, intake port 29, exhaust port 30 and a fly gear 31.

The timing gear 15 and the fly gear 31 have a housing 32 which is fastened to the valve disc housing 4 and the power disc 17.

The materials from which the valve disc motor 1 is constructed will depend on application, metals, ceramics, plastics etc.

The power disc 16 and the valve disc 2 are timed together by the meshing of the fly gear 31 and the timing gear 15.

Timing gear 15 motion is transferred through the timing gear shaft 33 then through the corner gears 12 and 13, hence to the valve disc 2.

As the power disc 16 rotates (as per drawings counterclockwise) one of the power cups 24, 25 or 26 approaches the valve disc 2. The valve disc 2 is so timed with the power disc 16 that the aperture 3 is in-,the correct position to allow the power cup 24, 25, or 26, to pass through the perimeter of the valve disc 2. As the power disc 16 rotates futher, so also does the valve disc 2 moving the aperture 3 into the valve disc housing 4 closing it. Further rotation of the power disc 16 creates a void between the power disc cup 24, 25 or 26, and the valv disc 2. Liquid or gas may then move or be moved into the void. If the liquid or gas are under pressure they will drive the motor 1. If the liquid or gas is detonated this also will drive the motor 1. If the liquid or gas is not under pressure the motor must be driven. The void becomes a vacuum, a liquid, or gas moves though the intake port 29 into the void and will be trapped between the power cups 24 and 25, 25 and 26, or 26 and 24 until the space between the power cups is again intersected by the valve disc 2. At which point pressure will develope between the backside of the power cups 24, 25 or 26 and the valve disc 2. Forcing the liquid or gas though the exhaust port 30. The exhaust process is the same whether the motor 1 is driving or being driven.

The discs 2 and 16 are machined within the closest tolerances possible. Clearance between the discs, 2 and 16, and their housings 4 and 17 is maintaned by the use of the tapered roller bearings 5, 6, 18 and 19 and their adjusters 9, 10, 22, and 23. Various condiments may be added depending on the application of the motor but the configuration and purpose of the discs remains the same though the discs 2 and 16 do not necessarily have to be at right angles to one another. The pressure vents 14, 27 and 28, allows for bypass gases or liquids to escape the motor preventing them from passing by the 7, 8, 20 and 22 and contaminating the bearings 5, 6, 18 and 19 or their lubricates.

The foregoing is considered as illustrative only of the principles of the invention. Further since numerous modifications and changes will readily occur to those skilled in the art, it is not desired to limit the invention to the exact construction and operation shown and described and accordingly all suitable modifications and equivalents may be resorted to, falling within the scope of the invention.

1. A transverse disc motor having one or more valve discs and one or more power discs rotating clockwise or counterclockwise, so timed and configured as to intersect in the appropriate manner ( as per the drawings and detailed description of this application ) for the reception or production of power, or for the transfer of liguids or gases.

2. The application of a rotating disc or discs, bearing mounted, acting as a barrier and or valve in the reception or production of power regardless of the angle at which the said valve disc is mounted in relation to the power discs.

3. The premise that a rotating disc mounted on the appropriate bearings can withstand substantial side force, without greatly affecting the amount of power required for its rotation in a motor application.
